(19) United States
(12) Patent Application Publication
(10) Pub. No.: US 2009/0101849 A1
(43) Pub. Date: Apr. 23, 2009

(54) Infrared ray generator for photoelectric finger pulse sensor

(76) Inventors: Renzhao Wu, Zhejiang (CN); Zhanggen Shou, Zhejiang (CN); Baiqi Zhang, Zhejiang (CN); Huagen Yan, Zhejiang (CN); Xin Wang, Zhejiang (CN)

Correspondence Address: ZHEN ZHENG LU, 1730 HUNTINGTON DRIVE #304, DUARTE, CA, 91010, US

(21) Appl. No.: 12/162,365

(22) PCT Filed: Jul. 14, 2006
(86) PCT No.: PCT/CN2006/001684

§ 371 Date: Jul. 28, 2008

(30) Foreign Application Priority Data
Feb. 17, 2006 (CN) 20061049532.X

(51) Int. Cl. G01J 1/00

(52) U.S. Cl. 250/495.1

(57) ABSTRACT

An infrared ray generator controlled by photoelectric finger pulse sensor comprises a carrier circuit, a photoelectric signal generating circuit, a photoelectric finger pulse signal receiving circuit, a signal anti-disturbing circuit, a carrier amplification circuit, a detecting and filtering circuit, a low pass amplifying circuit, an intelligent processing circuit, a voltage regulation circuit for triggering and controlling infrared ray lamp, and a power supply circuit for the infrared ray generator.

### BACKGROUND OF THE PRESENT INVENTION

1. Field of Invention

The present invention relates to an infrared ray generator, and more particularly to an infrared ray generator controlled by photoelectric finger pulse sensor.

2. Description of Related Arts

A former patent application of the applicant, adjustable infrared ray therapeutic device (95115529.6), mainly includes an heart rhythm signal sensor, infrared ray radiating device, a controlling box and a circuit, and it may further includes an external massage tool. The circuit includes a transformation and rectification circuit, a heart rhythm signal generation circuit, an amplification and filter circuit, a high and low voltage isolation circuit, and a modulation and voltage regulation circuit. This device is able to receive heart rhythm signal to adjust the up and down of the infrared ray radiation or the intense and rhythm of the massage, so as to consist the infrared ray rhythm with a user's heat rhythm and to produce an energy resonant effect of the same rhythm. However the device has a drawback. Because the infrared ray radiating device disturbs the heart rhythm signal generation circuit and the amplification and filter circuit while radiating, and the disturbed signal is sent back to trigger the infrared ray radiating device, the cycle of the signal results in a big deviation between the triggered rhythm of the infrared ray radiating device and the user's heart rhythm.

In order to overcome this problem, a user has to wear a black plastic bag around the hand after a heart rhythm signal sensor is put on the finger, so as to screen the disturbing signals. Using the plastic bag is not convenient and not good looking. Especially during the hot weather, the plastic bag will cause the uncomfortable feelings, such as hot and wet. In the other hand, when the device is in operation and the user takes off the heart rhythm signal sensor, the device is still in operation, unless the user turns off the device. This will cause the energy waste, and bring inconvenience to the use and operation of the device.

### SUMMARY OF THE PRESENT INVENTION

An object of the present invention is to avoid the black plastic bag being put on the heart rhythm signal sensor for eliminating the disturbance during the operation of the adjustable infrared ray therapeutic device, because the black plastic bag is inconvenient to use and not good looking; and to provide an infrared ray generator controlled by photoelectric finger pulse sensor, which does not need black plastic bag being put thereon, and is capable of effectively screening the disturbed signals, and is convenient to use and good looking.

Another object of the present invention is to prevent the energy waste produced by the infrared ray radiation device when the sensor being taken off. Because when the sensor is taken off, the infrared ray radiation device is still in operation and radiates infrared ray. Due to the limited lifespan of the device, the effective lifespan is reduced. Therefore, the present invention provide an infrared ray generator controlled by photoelectric finger pulse sensor, wherein when the sensor is taken off, the infrared ray radiation device does not work.

Accordingly, the solution to the above problem is illustrated hereinafter. The present invention includes a photoelectric signal generating circuit for collecting finger pulse, a photoelectric finger pulse signal receiving circuit for receiving the above mentioned signal, an amplifying circuit, a voltage regulation circuit for triggering and controlling infrared ray lamp, and a power supply circuit for the infrared ray generator, which are coupled in turn, wherein a carrier circuit is coupled with the photoelectric signal generating circuit, and a signal anti-disturbing circuit is coupled between the photoelectric signal generating circuit and the amplifying circuit, wherein the signal anti-disturbing circuit is an inductor DG coupled with the photoelectric finger pulse signal receiving circuit in parallel.

The infrared ray generator controlled by photoelectric finger pulse sensor carries the heart rhythm signal onto the carrier wave, and filter the disturbed signal from the infrared ray lamp through a parallel inductor, so that only heart rhythm signal is amplified, and the triggered rhythm of the infrared ray lamp consists with the heart rhythm of a user. The user does not need to wear a black plastic bag to cover the heart rhythm sensor, which is convenient to use and good looking.

In order to further improve the anti-disturbing effect, the signal anti-disturbing circuit further comprises a resistor R11 coupled with the inductor DG in parallel. The anti-disturbing circuit consisted of the inductor and resistor coupled in parallel can further assure the resistance of the disturbed signal and achieve a better performance.

Preferably, the amplifying circuit comprises a carrier amplification circuit and a low pass amplifying circuit; a detecting and filtering circuit is couple between the carrier amplification circuit and the low pass amplifying circuit.

After passing the above circuit, the carrier signal is amplified, and the carried signal is detected via the detecting and filtering circuit, so that the heart rhythm signal is obtained. The heart rhythm signal is transmitted to the voltage regulation circuit for triggering and controlling infrared ray lamp via the low pass amplifying circuit to control the radiation rhythm of the infrared ray lamp. This is a best mode to resist the disturbance to the infrared ray lamp, and further assure that the triggered rhythm of the infrared ray lamp consists with the heart rhythm of a user.

Preferably, an intelligent processing circuit is coupled between the low pass amplifying circuit and the voltage regulation circuit for triggering and controlling infrared ray lamp. The intelligent processing circuit has an operating program that can further assure the consistence of the triggered rhythm of the infrared ray lamp and the heart rhythm of a user via anti-disturbing software. Or coding and decoding the input signal through programming the single-chip computer, so that each device has its own identity to screen the input of the heart rhythm signal from other device to assure the infrared ray radiation rhythm to consist with the user's own heart rhythm.

Preferably, a standby mode recognizing circuit is coupled between the intelligent processing circuit and the amplifying circuit. The input end of the standby mode recognizing circuit is coupled with the output end of the detecting and filtering circuit, and the output end of the standby mode recognizing circuit is coupled with the input end of the intelligent processing circuit.

In the operating state of the infrared ray generator, when the user takes off the photoelectric finger pulse sensor, the receiver terminal still can receive some disturbed signals to trigger the infrared ray lamp wasting the energy. In order to avoid this case, the standby mode recognizing circuit can recognize the received signal not produced by the heart rhythm, and then the intelligent processing circuit will not send signal to the voltage regulation circuit for triggering and controlling infrared ray lamp. At the same time, each user can be allocated with one photoelectric finger pulse sensor of the device. In the operating state of the infrared ray generator, when the photoelectric finger pulse sensor is taken off from the device, the amplifying circuit of the device may receive some signals from the environment to trigger the infrared ray lamp causing the energy waste. In order to avoid this case, the standby mode recognizing circuit can recognize the received signal not produced by the heart rhythm, and then inform the intelligent processing circuit not to send signal to the voltage regulation circuit for triggering and controlling infrared ray lamp.

Preferably, the standby mode recognizing circuit comprises two amplifiers U2A and U2B, wherein the positive input ends of U2A and U2B are coupled with the output end of the detecting and filtering circuit, the negative input ends of U2A and U2B are grounded via two resistors R31 and R33 respectively and coupled to VCC via two resistors R32 and R34 respectively, and the output ends of the U2A and U2B are coupled to the positive poles of the diodes D2 and D3 respectively, wherein the negative poles of the D2 and D3 are coupled with two input pins of the intelligent processing circuit respectively. U2A recognizes whether the finger is put into the finger pulse cover or not, and U2B recognizes whether the finger pulse sensor is connected with the device or not. When the finger is not put into the finger pulse cover, or the finger pulse sensor is not connected with the device, the intelligent processing circuit will not send signal to the voltage regulation circuit for triggering and controlling infrared ray lamp.

Preferably, the intelligent processing circuit comprises a single-chip computer and a peripheral circuit coupled therewith.

Preferably, the carrier circuit comprises a single-chip computer and a peripheral circuit coupled therewith.

The above mentioned peripheral circuit is a variety of circuits to support the operation of the single-chip computer. Besides, the peripheral circuit can also include the reserved circuit in order to further expand the function of the present invention.

Preferably, the carrier circuit produces signal wave of 0.5 KHz to 10 KHz. The frequency of the signal wave can be predetermined according to the operation conditions, and can be adjusted according to the need in real time.

Preferably, the voltage regulation circuit for triggering and controlling infrared ray lamp comprises a photoelectronic coupler circuit S1. A series circuit of R1 and C13 are coupled to the photoelectronic coupler circuit S1 in parallel. A series circuit of a diode D11 and a relay J3 is coupled with J2 in parallel. Then one end is coupled to a relay J1, and the other end of the parallel circuit is coupled to the AC zero line via a relay J4 and the infrared ray lamp DP. The normally closed end of J1 is coupled to the 220V AC power, and the normally opened end of J1 is coupled to the 140V center tap of the T1. Through single-chip computer or self-lock button to control each relay to work in a different operation state, the infrared ray lamp can be adjusted to work in a full adjusted, half adjusted, not adjusted, full power, half power state to satisfy the different need of different users.

The benefit of the present invention is illustrated hereinafter. An inductor and a resistor paralleled to the photoelectric finger pulse signal receiving circuit effectively filters the disturbed signal produced by the infrared ray lamp, so as to assure that the triggered rhythm of the infrared ray lamp consists with the heart rhythm of a user. The black plastic bag is not needed any more, so that this device is convenient to use and good looking. The standby mode recognizing circuit and the intelligent processing circuit can recognize whether the finger is put into the finger pulse cover or not, or whether the finger pulse sensor is connected with the device or not, so as to determine whether the intelligent processing circuit sends signals to trigger the infrared ray lamp to save energy and to be easy to use and operate.

### BRIEF DESCRIPTION OF THE DRAWINGS

FIG. 1 is a block diagram of a circuit according to a preferred embodiment of the present invention.

FIG. 2 is a schematic view of a low-current part of the circuit according to the above preferred embodiment of the present invention.

FIG. 3 is a schematic view of a high-current part of the circuit (the power supply circuit and the voltage regulation circuit for triggering and controlling infrared ray lamp) according to the above preferred embodiment of the present invention.

### DETAILED DESCRIPTION OF THE PREFERRED EMBODIMENT

The following embodiments accompanied by the drawings further illustrate the present invention.

### Embodiment 1

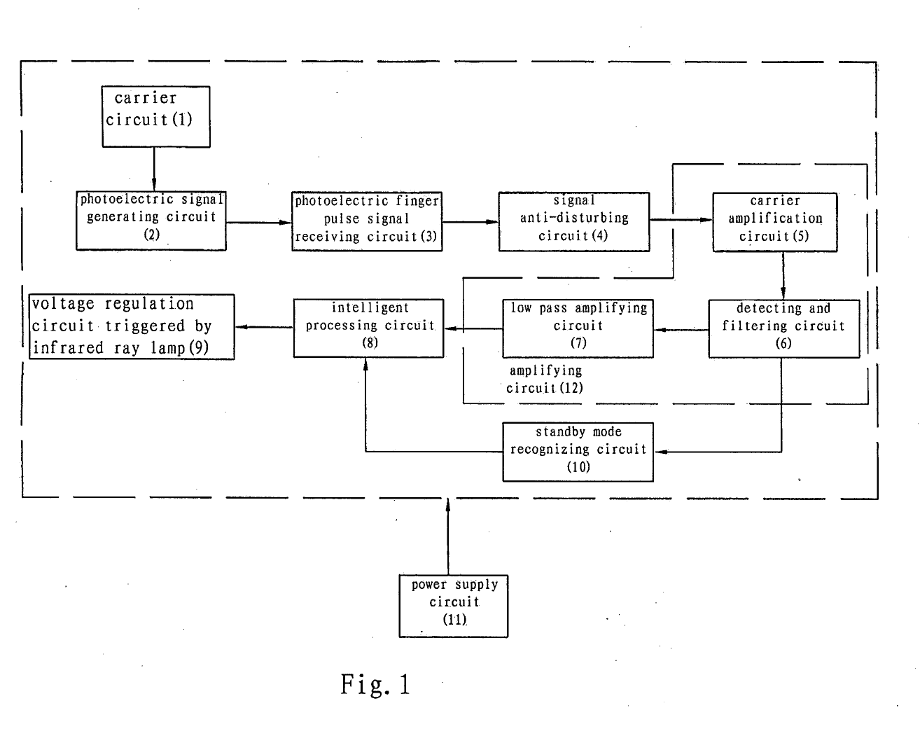

Referring to FIG. 1 of the drawings, an infrared ray generator controlled by photoelectric finger pulse sensor of the present invention comprises a photoelectric finger pulse cover, a controlling box, and an infrared ray lamp coupled in turn. A photoelectric signal generating circuit 2 coupled with a carrier circuit 1 is mounted on one side of the photoelectric finger pulse cover, and a photoelectric finger pulse signal receiving circuit 3 is mounted on the other side of the photoelectric finger pulse cover. A circuit device is provided in the controlling box, wherein an input end of the circuit device is coupled with the output end of the photoelectric finger pulse signal receiving circuit 3. The circuit of the circuit device comprises a signal anti-disturbing circuit 4, a carrier amplification circuit 5, a detecting and filtering circuit 6, a low pass amplifying circuit 7, an intelligent processing circuit 8, an voltage regulation circuit 9 for triggering and controlling infrared ray lamp, and a power supply circuit 11 for providing power to the infrared ray generator coupled in turn. A standby mode recognizing circuit 10 is coupled between the detecting and filtering circuit 6 and the intelligent processing circuit 8. An amplifying circuit 12 comprises a carrier amplification circuit 5, a detecting and filtering circuit 6, a low pass amplifying circuit 7 coupled in series.

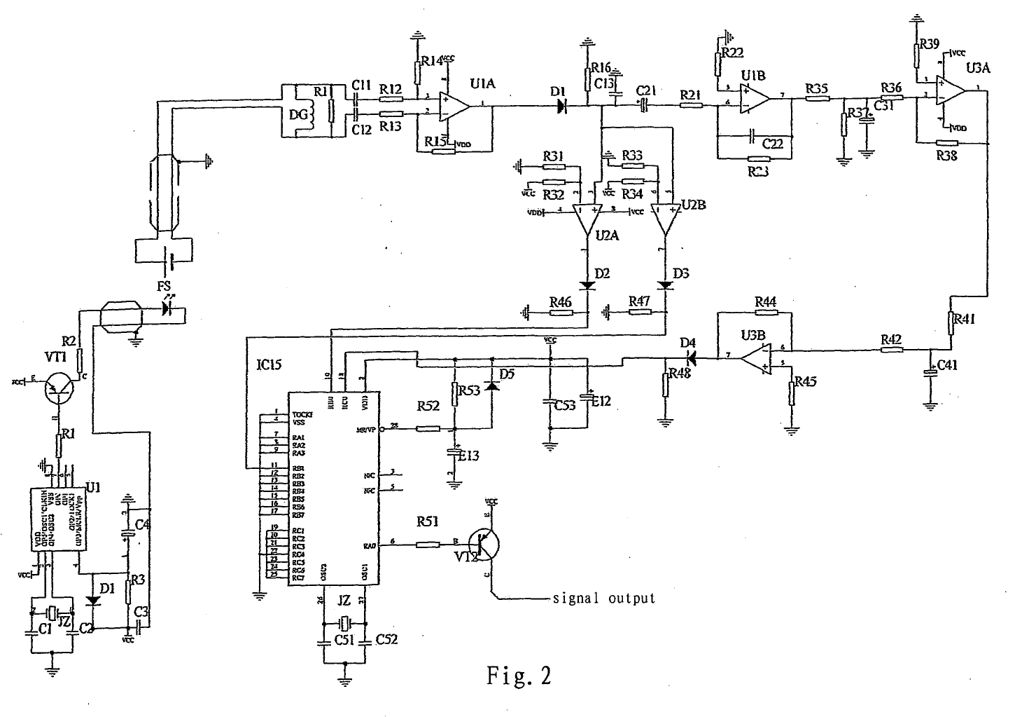

As shown in FIG. 2, the carrier circuit 1 comprises a single-chip computer PIC12C508 and a peripheral circuit coupled therewith. The single-chip computer PIC12C508 stores an operating program. The output pin GPO of the single-chip computer PIC12C508 is coupled to the base of the transistor VTI via a resistor R1, and the collector of transistor is coupled with the positive pole of a light emitting diode (photoelectric signal generating circuit) via a resistor R2, to produce a 1 KHz signal wave. The carrier circuit can be embodied as other oscillation circuit. The signal anti-disturbing circuit 4 comprises an inductor DG coupled with a photoelectric cell (photoelectric finger pulse signal receiving circuit 3) in parallel and a resistor R11. The parallel circuit is coupled with the two input ends of the carrier amplification circuit 5 via a capacitor C11 and a resistor R12, and a capacitor C12 and a resistor R13 respectively, wherein the carrier amplification circuit 5 comprises an amplifier U1A. The positive pole of the diode D1 having a detecting function is coupled with the output end of the U1A, and the negative pole of D1 is grounded via a capacitor C13 having a filtering function. At the same time, the negative pole of D1 is coupled with the low pass amplifying circuit 7 comprising amplifiers U1B, U3A, and U3B, and the output end of the U3B is coupled with an input end of the intelligent processing circuit 8 via a diode D4. In this embodiment, the intelligent processing circuit 8 comprises a single-chip computer and a peripheral circuit coupled therewith. The single-chip computer is the PIC series, and the negative pole of D4 is coupled with the RCO pin of the single-chip computer. The standby mode recognizing circuit 10 comprises two amplifiers U2A and U2B, wherein the positive input ends of U2A and U2B are coupled with the negative pole of the diode D1, the negative input ends of U2A and U2B are grounded via two resistors R31 and R33 respectively and coupled to VCC via two resistors R32 and R34 respectively, and the output ends of the U2A and U2B are coupled to the pins RBO and RB1 via diodes D2 and D3 respectively. The RAO pin of the single-chip computer is coupled to the base of the transistor VT2, the emitter of the VT2 is coupled with the power source VCC, and the collector of the VT2 is coupled with the input end of the voltage regulation circuit for triggering and controlling infrared ray lamp.

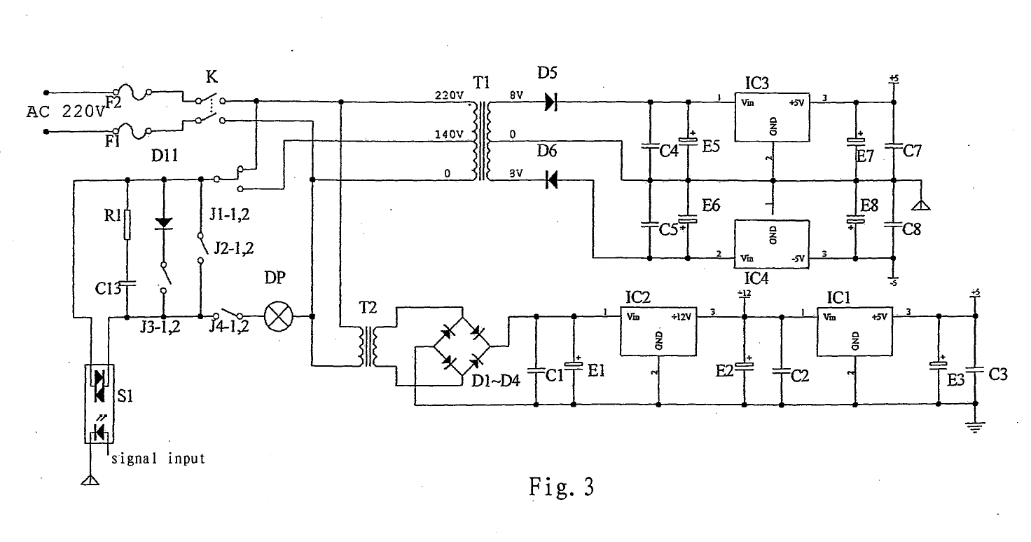

As shown in FIG. 3, the power supply circuit II comprises transformers T1 and T2, whose output ends can supply all kinds of DC voltage via being rectified and stabilized. The voltage regulation circuit 9 for triggering and controlling infrared ray lamp comprises a photoelectronic coupler circuit S1. The positive pole of the light emitting diode of the photoelectronic coupler circuit S1 is coupled with the collector of the transistor VT2. A series circuit of R1 and C1 are coupled to the photoelectronic coupler circuit S1 in parallel. A series circuit of a diode D11 and a relay J3 is coupled with J2 in parallel. Then one end of the parallel circuit is coupled to the AC zero line via a relay J4 and the infrared ray lamp, and the other end is coupled to a relay J1. The normally closed end of J1 is coupled to the 220V input pin of the transformer T1, and the normally opened end of J1 is coupled to the 140V center tap of the T1.

The operation process of the present invention is illustrated hereinafter. The heart rhythm signal reflected by the finger in the photoelectric finger pulse cover is carried onto the single-chip computer and the 1 KHz carrier wave produced by the peripheral circuit of the single-chip computer forming a carrier signal. The carries signal is received by the photoelectric finger pulse signal receiving circuit. At the same time the disturbed signal produced by the infrared ray lamp is also received by the photoelectric finger pulse signal receiving circuit. However, the disturbed signal can be effectively filtered through an inductor DG and a resistor R11. At this time, the signal the U1A amplifies is effective carrier signal, and after the detection of the diode D1 and the filtering of the capacitor C13, 1 KHz signal wave is get rid of and an effective heart rhythm signal is obtained. The effective heart rhythm signal is amplified, and then transmitted to the voltage regulation circuit for triggering and controlling infrared ray lamp through an anti-disturbing software of the single-chip computer to trigger the radiation of the infrared ray lamp, so as to avoid the disturbance produced by the infrared ray lamp. Therefore, the triggered rhythm of the infrared ray lamp consists with the heart rhythm of a user, and the user does not need to wear a black plastic bag to cover the heart rhythm sensor in order to resist disturbance.

On the other hand, in the operating state, when the photoelectric finger pulse cover does not receive finger, or the photoelectric finger pulse cover is separated from the circuit device in the controlling box, the controlling box can also receive the disturbed signals produced in the surrounding environment. Then the standby mode recognizing circuit consisted of amplifiers U2A and U2B can detect this standby mode, and sends detected signal to the single-chip computer as an intelligent processing circuit. The single-chip computer determines not to send signal to the voltage regulation circuit for triggering and controlling infrared ray lamp, so that the infrared ray lamp does not work to effectively avoid mishandling, save energy, and be convenient to use and operate. The relays J1, J2, J3 and J4 of the voltage regulation circuit for triggering and controlling infrared ray lamp can be controlled by the single-chip computer or self-lock button. J1 has power adjusting function, and can let the lamp DP working in a full power or a half power state; when J2 is switched on, all DPs are illuminating and do not received the adjusting signal from S1; when J2 is switched off and J3 is switched on, the DP is half adjusted; when J2 is switched off and J3 is switched off, the DP is fully adjusted; when J4 is switched off, DP is turn off. Through the on and off combination of the J1, J2, J3 and J4, the infrared ray lamp DP can work in the different state to satisfy different needs of the users.

The commonly used circuit referred in the preferred embodiment, such as the peripheral circuit of the single-chip computer, can be obtained by the ordinary technical personnel without creative work, so that it is not illustrated in the preferred embodiment.

One skilled in the art will understand that the embodiment of the present invention as shown in the drawings and described above is exemplary only and not intended to be limiting. It embodiments have been shown and described for the purposes of illustrating the functional and structural principles of the present invention and is subject to change without departure from such principles. Therefore, this invention includes all modifications encompassed within the spirit and scope of the following claims.

The preferred embodiment uses glossary of 1 a carrier circuit, 2 a photoelectric signal generating circuit, 3 a photoelectric finger pulse signal receiving circuit, 4 a signal anti-disturbing circuit, 5 a carrier amplification circuit, 6 a detecting and filtering circuit, 7 a low pass amplifying circuit, 8 an intelligent processing circuit, 9 a voltage regulation circuit for triggering and controlling infrared ray lamp, 10 a standby mode recognizing circuit, 11 a power supply circuit for the infrared ray generator, 12 an amplifying circuit. However, other glossary may be used. These glossaries are only to conveniently describe and illustrate the nature of the present invention, so that these glossaries cannot be explained to have any additional limitation.

1. An infrared ray generator controlled by photoelectric finger pulse sensor comprising a photoelectric signal generating circuit, a photoelectric finger pulse signal receiving circuit for receiving the signal, an amplifying circuit, a voltage regulation circuit for triggering and controlling infrared ray lamp, and a power supply circuit for infrared ray generator, which are coupled in turn, wherein a carrier circuit is coupled with said photoelectric signal generating circuit, and a signal anti-disturbing circuit is coupled between said photoelectric finger pulse signal receiving circuit and said amplifying circuit, wherein said signal anti-disturbing circuit is a inductor coupled with said photoelectric finger pulse signal receiving circuit in parallel.

2. The infrared ray generator controlled by photoelectric finger pulse sensor, as recited in claim 1, wherein said signal anti-disturbing circuit further comprises a resistor R11 coupled with said inductor in parallel.

3. The infrared ray generator controlled by photoelectric finger pulse sensor, as recited in claim 1, wherein said amplifying circuit comprises a carrier amplification circuit and a low pass amplifying circuit, wherein a detecting and filtering circuit is couple between said carrier amplification circuit and said low pass amplifying circuit.

4. The infrared ray generator controlled by photoelectric finger pulse sensor, as recited in claim 3, wherein said an intelligent processing circuit is coupled between said low pass amplifying circuit and said voltage regulation circuit for triggering and controlling infrared ray lamp.

5. The infrared ray generator controlled by photoelectric finger pulse sensor, as recited in claim 4, wherein a standby mode recognizing circuit is coupled between said intelligent processing circuit and said amplifying circuit, wherein an input end of said standby mode recognizing circuit is coupled with an output end of said detecting and filtering circuit, and an output end of said standby mode recognizing circuit is coupled with an input end of said intelligent processing circuit.

6. The infrared ray generator controlled by photoelectric finger pulse sensor, as recited in claim 5, wherein said standby mode recognizing circuit comprises two amplifiers U2A and U2B, wherein two positive input ends of U2A and U2B are coupled with an output end of said detecting and filtering circuit, two negative input ends of U2A and U2B are grounded via two resistors R31 and R33 respectively and coupled to VCC via two resistors R32 and R34 respectively, and two output ends of said amplifiers U2A and U2B are coupled to two positive poles of two diodes D2 and D3 respectively, wherein two negative poles of the D2 and D3 are coupled with two input pins of said intelligent processing circuit respectively.

7. The infrared ray generator controlled by photoelectric finger pulse sensor, as recited in claim 4, wherein said intelligent processing circuit comprises a single-chip computer and a peripheral circuit coupled therewith.

8. The infrared ray generator controlled by photoelectric finger pulse sensor, as recited in claim 1, wherein said carrier circuit comprises a single-chip computer and a peripheral circuit coupled therewith.

9. The infrared ray generator controlled by photoelectric finger pulse sensor, as recited in claim 1, wherein said carrier circuit produces signal wave of 0.5 KHz to 10 KHz.

10. The infrared ray generator controlled by photoelectric finger pulse sensor, as recited in claim 1, wherein said voltage regulation circuit for triggering and controlling infrared ray lamp comprises a photoelectronic coupler circuit S1, a series circuit of R1 and C13 are coupled to said photoelectronic coupler circuit S1 in parallel, a series circuit of a diode D11 and a relay J3 is coupled with J2 in parallel, then one end is coupled to a relay J1 and the other end is coupled to an AC zero line via a relay J4 and said infrared ray lamp, wherein a normally closed end of J1 is coupled to a 220V AC power, and a normally opened end of J1 is coupled to a 140V center tap of a transistor T1.

11. The infrared ray generator controlled by photoelectric finger pulse sensor, as recited in claim 2, wherein said carrier circuit comprises a single-chip computer and a peripheral circuit coupled therewith.

12. The infrared ray generator controlled by photoelectric finger pulse sensor, as recited in claim 3, wherein said carrier circuit comprises a single-chip computer and a peripheral circuit coupled therewith.

13. The infrared ray generator controlled by photoelectric finger pulse sensor, as recited in claim 2, wherein said carrier circuit produces signal wave of 0.5 KHz to 10 KHz.

14. The infrared ray generator controlled by photoelectric finger pulse sensor, as recited in claim 3, wherein said carrier circuit produces signal wave of 0.5 KHz to 10 KHz.

15. The infrared ray generator controlled by photoelectric finger pulse sensor, as recited in claim 2, wherein said voltage regulation circuit for triggering and controlling infrared ray lamp comprises a photoelectronic coupler circuit S1, a series circuit of R1 and C13 are coupled to said photoelectronic coupler circuit S1 in parallel, a series circuit of a diode D11 and a relay J3 is coupled with J2 in parallel, then one end is coupled to a relay J1 and the other end is coupled to an AC zero line via a relay J4 and said infrared ray lamp, wherein a normally closed end of J1 is coupled to a 220V AC power, and a normally opened end of J1 is coupled to a 140V center tap of a transistor T1.
